(19) United States
(12) Patent Application Publication
(10) Pub. No.: US 2022/0236224 A1
(43) Pub. Date: Jul. 28, 2022

(54) INDUCTIVE SENSOR WITH A MAGNETIC BIASED COIL FOR EDDY CURRENT TESTING

(71) Applicant: GOWell International, LLC, Houston, TX (US)

(72) Inventors: Alexander Tarasov, Houston, TX (US); Ryan Rugg, Cypress, TX (US); Jinsong Zhao, Houston, TX (US)

(21) Appl. No.: 17/573,631

(22) Filed: Jan. 11, 2022

Related U.S. Application Data
(60) Provisional application No. 63/141,467, filed on Jan. 25, 2021.

(51) Int. Cl. G01N 27/90; G01D 5/20

(52) U.S. Cl. CPC G01N 27/9006; G01D 5/20; G01N 27/9046

(57) ABSTRACT

A method and apparatus for enhancing inductive sensor sensitivity response, controlling the signal dynamic range, and maximizing linearity. The apparatus includes an inductive sensor-based inspection apparatus with a ferromagnetic core, a transmitter coil, a receiver coil, and a magnetic bias coil. Biasing the sensor with a static and/or dynamic magnetic fields shifts the permeability value on a B-H curve of the ferromagnetic core to the region to provide a better linearity in a controllable dynamic range and stronger signal response with a higher SNR for enhancing detectability and measurability of minor changes of decaying magnetic field deep inside the metal target under inspection. Furthermore, the method includes adaptive biasing capabilities to dynamically adjust the magnetic bias level for an optimal signal response in measurement sensitivity, signal dynamic range, SNR, and linearity from the inductive transducer in the invention. A signal processing method is provided to remove the impacts from the biased magnetic field when needed.

### CROSS-REFERENCE TO RELATED APPLICATIONS

The present application claims priority from the U.S. Provisional Patent Application Ser. No. 63/141,467, filed on Jan. 25, 2021, and entitled “Gain Configurable Inductive Sensor Biased Actively by a Magnetic Field For High Sensitivity and Linearity”, which is incorporated herein by reference in its entirety.

### FIELD OF INVENTION

The present invention relates to sensors for eddy current testing to detect and characterize surface and sub-surface flaws in conductive materials, and more particularly, the present invention relates to an inductive sensor with improved measurement sensitivity and/or reduce the nonlinearity.

### BACKGROUND OF THE INVENTION

In general, Eddy current (EC) testing makes use of electromagnetic inductive principle to detect and characterize surface and sub-surface flaws in conductive materials. A standard pulse eddy current (PEC) method induces circular eddy currents into the surface layer of the metal target through the sudden change of the equilibrium magnetic field by fast switching off the stable charging current in the transmitter coil. The EC generates the magnetic field that can be detected by the receiver coil as an EC “echo signal”. The EC on the surface layer rapidly decreases in strength due to the thermal dissipation of the resistance from the target metal body. The changes of EC on the surface layer cause the magnetic field strength change that induces the secondary EC further into the deeper layer where the secondary EC starts decaying as well due to resistance. The process repeats and keeps going until all energy is burned out along time in the depth inside the metal body. This process is well known as EC diffusion and damping. During the process, EC goes deeper and becomes weaker along the depth. As the result, the associated magnetic field strength reduces over time. The detection signal from the magnetic strength change on the receiver coil is decayed accordingly as well. The received time transient signal can be analyzed to identify resistance changes along the time corresponding to the depth from the surface, which can then be used for detecting and locating the defects on the surface and under the surface of the metal target. The deeper the EC penetrates, the smaller the signal is received on the receiver coil. In principle, PEC has a very large signal dynamic range for deep detection applications, normally around 120 dB or more, from the target. In addition, the sensitivity of received signal depends on the sensor core ferromagnetic permeability which decreases gradually along the magnetic field strength decay corresponding to the Eddy Current decay. As the result, the signal along time for the depth from the target becomes lower and less sensible by the core as part of the sensor, resulting in a low Signal-to-Noise Ratio (SNR). In addition, the range of sensitivity changes (up to 40 dB in difference) corresponding to the core permeability decrease over the magnetic field strength shows a strong nonlinearity of the signal from the receiver coil measurements.

Thus, an industry need exists for an apparatus and method that is devoice of the drawbacks and limitations of the existing eddy current testing methods.

Hereinafter, the abbreviation “EC” refers to “eddy current(s)”, SNR refers to signal to noise ratio, and PEC refers to “Pulsed Eddy Current”, all are known in the art.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to an inductive sensor apparatus that statically or dynamically adjusts a magnetic bias level to achieve an optimal sensitivity response.

It is another object of the present invention that the inductive sensor apparatus has a stronger signal response with high sensitivity.

It is still another object of the present invention that the inductive sensor apparatus has higher linearity for the response signal.

It is yet another object of the present invention that the inductive sensor apparatus has a wider signal response dynamic range for higher measurement resolution.

It is a further object of the present invention that the inductive sensor apparatus has a higher signal-to-noise ratio (SNR).

In one aspect, disclosed is an inductive sensor apparatus for nondestructive testing of metallic objects. This inductive sensor apparatus has a ferromagnetic core, a transmitter coil and a receiver coil wound on the ferromagnetic core, and a magnetic bias coil positioned around the ferromagnetic coil. The receiver coil is separate from the transmitter coil. The magnetic bias coil is adapted to apply an electric current to build up a bias magnetic field inside the ferromagnetic core to shift permeability of the ferromagnetic core to a desired level. The magnetic bias coil is separated, normally, from the transmitter coil and the receiver coil. However, it can be shared entirely and partially with the transmitter coil by designs.

In one aspect, a network with a current source supported by a power supply and a controllable switch is connected to the transmitter coil such that a current is applied to and can be switched off on the ferromagnetic core in order to induce an eddy current on the surface layer of the metallic object. A separate current source can be connected to the magnetic bias coil. The electric current can be applied to the magnetic bias coil to shift the permeability of the ferromagnetic core when receiving the EC echo signal from the metal target.

In one implementation of the inductive sensor apparatus, the receiver coil, the transmitter coil, and magnetic bias coil, all can be positioned into separate sections along the core or overlapped with each other in layers over the core as dictated by designs for various applications. The ferromagnetic core can be a single ferromagnetic core.

These and other objects and advantages of the present invention will become apparent from reading attached specifications and appended claims. Also, the foregoing Section is intended to describe, with particularity, the preferred embodiments of the present invention. It is understood that modifications to these preferred embodiments can be made within the scope of the present claims. As such, this section should not be construed, in any way, as limiting of the broad scope of the present invention. The present invention should only be limited by the following claims and their legal equivalents.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a diagrammatic illustration of an inductive sensor apparatus of the prior art.

FIG. 2 is a graph showing the PEC based on sensor current charging and EC echo signal decaying curve of the prior art.

FIG. 3 is a graph showing an example of measurement logs in B-mode scan (VDL plot) for the defects or desired characteristics of EC decays with respect to different SNRs.

FIG. 4 is a graph showing the core permeability characteristics in terms of sensitivity and nonlinearity.

FIG. 5 is a diagrammatic illustration of the disclosed and its symbolic network model, according to an exemplary embodiment of the present invention.

FIG. 6 illustrates the method, network connections, and the output corresponding signals to control the shift of the signal working zone from low in sensitivity and high in nonlinearity to considerably high in sensitivity and low in nonlinearity, according to an exemplary embodiment of the present invention.

FIG. 7 is a graph showing the lab verification result as a proof of concept (POC) of the disclosed inductive sensor apparatus, according to an exemplary embodiment of the present invention.

FIG. 8 is a diagrammatic illustration of choosing different control currents for the use of different biased magnetic fields to shift the signal working zones for adapting various signal dynamic ranges and characteristics associated with the inductive sensor apparatus, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

Disclosed is an inductive sensor apparatus and method for nondestructively evaluating metallic surfaces using a PEC principle with enhanced signal acquisition topology. The disclosed inductive sensor apparatus may comprise a transmitter coil to generate a static magnetic field by the means of exciting the coil with a certain amount of current, and then switching off the current. The initial EC is induced on the surface of the metal object and gradually decays inside the target due to diffusion and damping processes. Those skilled in the art will recognize that the eddy currents can be induced by any other means without departing from the scope of the present invention. The inductive sensor apparatus may also include a separate receiver coil which can detect decaying magnetic field due to EC decaying. The receiver coil generates a voltage signal in response to the EC magnetic field change which, when analyzed further, reveals the target's features, such as thickness or defects that alter the metal resistances. The inductive sensor apparatus also includes an adaptive bias coil that is utilized to boost the signal working range to an optimal working region which results in a higher SNR, sensitivity, dynamic range, and linearity. The following description of the illustrations will further provide a thorough understanding of the invention.

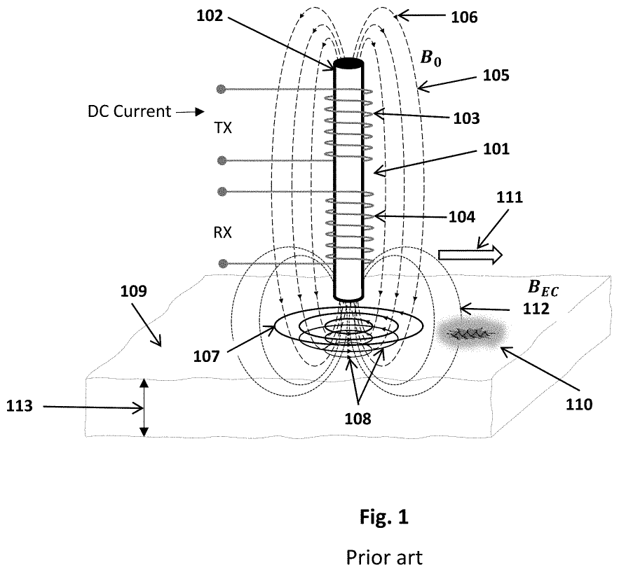

Referring to FIG. 1 illustrates, in general, an inspection apparatus in accordance with the prior art. Such an apparatus consists of a transducer 101, a core 102, a transmitter coil 103, and a receiver coil 104. Both the transmitter coil 103 and the receiver coil 104 are wound on the core 102. The material of the core 102 is normally a ferromagnetic material with high magnetic permeability value for high signal sensitivity. However, it can also be non-ferromagnetic. The transducer 101 can be used to measure the features, properties, and/or flaws 110 of the metallic object 109. The test object 109 can be any metallic object which includes, but not limited to pipes, plates, sheets, structures, and so on. The transmitter coil 103 produces magnetic field 105 with the flux direction shown by arrows 106, also known as magnetic flux density field distribution function, when a DC current is applied across the transmitter coil 103. The magnetic field 105 is stabilized after some time duration. When the current is removed by switching off from the transmitter 103 and the magnetic field 105 collapses, a circular EC 107 is induced due to the changing magnetic field 105 on the surface of the metallic object 109. The circularly flowing EC 107 on metallic object 109 generate EC associated magnetic field flux 112 getting into the core 102. Due to thermal power dissipation from resistance of the metallic object 109, the EC 107 continuously decays, which results in the subsequent magnetic field 112 decay. Changes of the magnetic field 112, induce the secondary EC 108 in nearby conductive layers under the surface of the metallic object 109. Due to the same reason of thermal power dissipation as for EC 107, EC 108 decays along the time. The inductive-while-decaying process of EC 108 keeps repeating as EC penetrating deeper into the metallic object 109 and becoming weaker and weaker over time. The behavior of EC decaying process is called diffusion and damping. Eventually, the EC get dissipated out along time and depth inside the metallic object 109. The corresponding magnetic field 112 inside the core 102 keeps decreasing along with the EC 108 decaying. The changes of the magnetic field 112 associated with EC decaying are sensed by the receiver coil 104, which develops a voltage signal in response. The resultant voltage signal can be measured and then further analyzed in the post-processing domain to extract properties of the metallic object 109 such as thickness changes 113 and/or flaws 110.

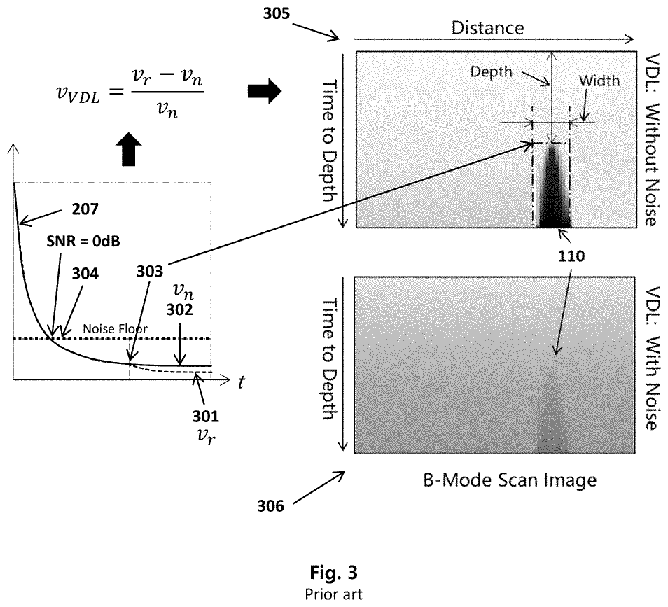

As EC diffuses and dampens inside the body of the metallic object 109, the strength of the EC is reduced as illustrated above. In principle, the time and the depth can be mapped with respect to each other. As the result, the signal decay along time measured from receiver coil 104 can be translated into the signal decay along the depth. Eventually the measured signal from receiver coil 104 decreases along the depth to an unmeasurable level and the signal acquisition time is over, which corresponds to a one-round measurement process of PEC detection sequence. The measurement process may be repeated at a stationary position to measure the same location multiple times to acquire multiple data frames. This combined data would then be stacked and averaged to obtain higher Signal-to-Noise Ratio (SNR) than a single frame of acquired data. The measurement process may also be repeated while in motion, shown by an arrow 111 in FIG. 1, for scanning while measuring the target area of the metallic object 109. The scanning while measuring motion can be achieved by moving either the transducer 101 or the target 109 in a scanning way against the transducer. The scanning signals can be built and presented in 2D or 3D B-Mode scan image. The example of a 2D B-Mode scan image is shown in FIG. 3.

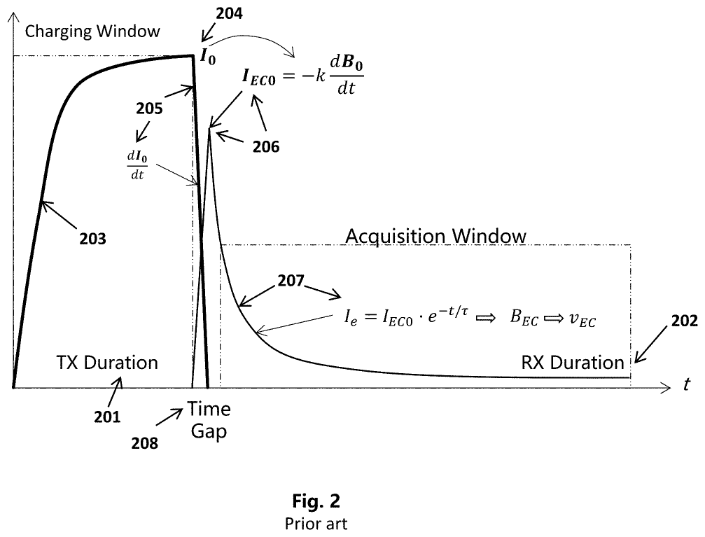

FIG. 2 shows typical profiles of an excitation current pulse 203 when applied to the transmitter coil 103 and the received time-transient measurement voltage signal 207 corresponding to the EC 108 decaying, along the time, sensed in the receiver coil 104, as illustrated in the embodiment shown in FIG. 1. For the TX charging current pulse 203, the stable state of the magnetic field B₀ 105 is required while the core 102 is charged by the charging current 203 until it reaches the stable level as shown as I₀ 204. The charging process 203 takes time denoted in FIG. 2 as the TX charging window and as the TX duration 201. At the beginning of charging, the current is applied to the transmitter coil 103 and gradually builds up as shown in 203 until it plateaus at I₀ 204. The stable magnetic B₀ 105 field in the core 102 is established. As a result, the portion of the static magnetic field B₀ 105 through the flux distributions in the metallic object 109 is also established. The sudden removal of the charging current I₀ 204 from the transmitter coil 103 produces the corresponding changes in magnetic field B₀ 105 both in the core 102 and in the metallic object 109. The portion of the B₀ flux 105 in the metallic object 109 induces the initial EC 107 as I_{ECO} in

$${I}_{EC 0} = - k \frac{d {B}_{0}}{dt} and k < 1 \qquad ( 1 )$$

on the surface of the metallic object 109. Then the process of EC 107/108 decaying starts as illustrated in FIG. 1. As the result, the EC 108 decaying along the time can be shown in the following:

$${I}_{e} = {I}_{EC 0} {e}^{- t / τ} and τ ∝ \frac{{μ}_{m}}{{ρ}_{m}} \qquad ( 2 )$$

where, μₘ is the magnetic permeability and ρₘ is the resistivity of the metallic object 109.

The equation (2) shows that when the resistivity of the target region increases, the τ decreases, and the EC 108 decay is faster along the time. In this case, EC 108 shall be smaller than in the region of the defect 110 after the certain time point when EC reaches the depth where the defect 110 is located, compared to the region without any defects. The EC 108 generates the secondary magnetic field B_{EC} 112 that can be sensed by the receiver coil 104 along the time as the received voltage signal ν_{EC} shown as curve 207 following in

$${v}_{E C} = - N A \frac{d {B}_{E C}}{dt} = {μ}_{C} N A \frac{{dH}_{E C}}{dt} and {B}_{E C} = {μ}_{C} {H}_{E C} \qquad ( 3 )$$

where, N is the number of turns of the receiver coil 104; A is the section area of the core 102; B_{EC} is the magnetic field inside the core 102; μ_{C} is the magnetic permeability of the core 102; and H_{EC} is the magnetic strength distribution generated by EC 108. From the equation (3), the changes of EC 108 decay are sensed by the receiver coil 104 as the received signal ν_{EC} that represents the EC 108 decaying process. From the equation (2), the EC 108 decaying along time is linked to the local properties, such as the resistivity, of the measurement target, such as the metallic object 109. There is the time gap 208 right after the charging window and before the acquisition window for measuring the EC decaying. Within the time gap 208, the sudden change of the magnetic field B₀ inside the core generates the high voltage on the transmitter coil 103 through self-inductive process as well as the high voltage on the receiver coil 104 through mutual-inductive process. Both high voltages, normally called “switching interferences”, can be sensed on the receiver coil 104 as the received signal that is not from the target EC 107/108 decaying process measured as voltage signal 207. As a result, the initial portion of EC 107/108 decay in received signal 207 within the time gap 208 is heavily contaminated by the switching interferences. Normally, those interference signal voltages are damped close to zero in short time within the time gap 208 by using active and/or passive damping networks. After the time gap 208, the EC 108 decay from the target without the switching interferences can be detected reliably as the voltage signal 207 received from the receiver coil 104. The RX duration 202 is for the signal 207 acquisition duration in which EC 108 decaying is measurable. After 202, the magnetic B_{EC} change in the core 102 along the time,

$$\frac{d {B}_{E C}}{dt}$$

can no longer be sensible and measurable.

FIG. 3 illustrates the analysis and the presentation of the decaying voltage curve 207, which is used for extracting the defect 110, which, as one of the examples of features of the metallic object 109, could be a small fracture inside the body 113 of metallic target 109. The main challenges of using the PEC testing method are the measurement sensitivity, signal dynamic range, and SNR. In FIG. 3, the received voltage signal 207 may have a high dynamic range of up to −100 dB to −140 dB decaying along the time and the depth. When diffusing EC 108 reaches the defect region underneath the surface, the circular current I_{EC} flows through the defect 110 region. The resistance R_{EC} along the circular EC path increases due to the changes of metal conductivity properties caused by the defect 110, resulting in the thermal power dissipation increases proportionally to I_{EC}²R_{EC} based on the Ohm's Law. Therefore, the received signal 301 of the decaying EC 108 after the time point 303 when EC reaches the defect 110 region is faster and lower than the received signal 302 in the region without defect 110. When defining the received signal 302 as the nominal signal νₙ and the rest of measurement signals including the received signal across the defect 110 area as the test signal νᵣ, can be obtained the relative measurement signal ν_{VDL}, as a Variable Depth Log (VDL) signal as

$${v}_{V D L} = \frac{{v}_{r} - {v}_{n}}{{v}_{n}} \qquad ( 4 )$$

When scanning across the defect 110 area, the ν_{VDL}, can be presented in gray scales as 2D B-Mode Scan Image coordinated in distance and depth mapped from the time of the EC decaying process. Without system noises, the B-Mode Scan Image is shown in 305. The depth and width of the defect 110 can be viewed and estimated. The time point 303 is mapped in depth in the B-Mode Scan Image 305. When the system noise 304 is present, which is always the case in the real-world environment, the SNR of the measurement signal 302 may change from high in positive to low or even negative along the time after the point of SNR=0 dB while EC decays continuously. As the decaying signals 302 and 301 cross the noise floor 304, they suffer from noise interference as shown on the B-Mode Scan Image 306, resulting in difficulties for viewing and estimating, both in accuracy and precision, the depth and width of the defect 110. In addition, the defects may be buried very deep inside the metallic object 109 and the decaying signal responses may be very small, which requires exceptionally high sensitivity as well as wide signal dynamic range from the transducer 101 for measurements.

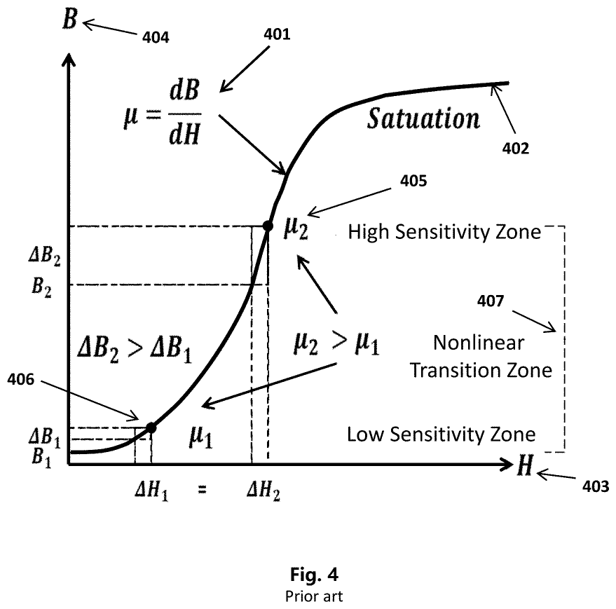

FIG. 4 depicts sensitivity and linearity challenges that this invention addresses. The equation (3) shows that the permeability μ_{C} of the core 102 is proportional to the received signal ν_{EC} given the EC decaying magnetic strength H_{EC} changes in the core 102. To increase the sensitivity of the received signal ν_{EC} for H_{EC} changes, ferromagnetic materials with high magnetic permeability μ_{C} are normally selected to construct the core 102. However, the permeability μ_{C} of a ferromagnetic material is not constant or linear but is instead a nonlinear function of magnetic field 404 vs magnetic strength 403, typically, shown in the permeability B-H curve 401. In this case, the magnetic permeability of a sensor core is defined as

$$μ = \frac{d B}{d H} \qquad ( 5 )$$

On the B-H curve 401, the μ₂ at the point 405 is larger than the μ₁ at the point 406, given the same amount of EC decaying magnetic 112 strength change in ΔH₁ at the point 406 and ΔH₂ at the point 405 where ΔH₁=ΔH₂. It then follows that the corresponding ΔB₁ at the point 406 and ΔB₂ at the point 405 are different where ΔB₂>ΔB₁ due to μ₂>μ₁. From Equation (3), ν₂>ν₁ for the same EC decaying changes in ΔH depending upon the magnetic field B level inside the core. It is clear that B₂>B₁ at points 405 and 406 on the B-H curve 401. Because of the B-H curve of ferromagnetic cores, the received voltage signal ν_{EC} may have reduced sensitivity and exhibit high nonlinearity due to core permeability behavior against a wide dynamic range of the decaying EC 108 along time. FIG. 4 depicts four regions of operation—the saturation region 402, the high sensitivity around the point 405, the low sensitivity zones around the point 406, and the nonlinear transition where the magnetic field spans a wide range from the point 405 to the point 406. When the EC decays to very low level where the magnetic field in the core is far below the point 406, the permeability from Equation (5) is near zero on the B-H curve 401. As the result, the received voltage signal ν_{EC} will also appear close to zero and become almost unsensible, according to Equation (3), even though ΔH remains none-zero and measurable. As can be seen, the ideal signal working region of operation is that with high sensitivity and low nonlinearity where the μ₂ value is positioned. If the permeability could stay within a narrow region relatively constant over time, then the received voltage signal measurement response ν_{EC} would have a strong sensitivity and less nonlinearity.

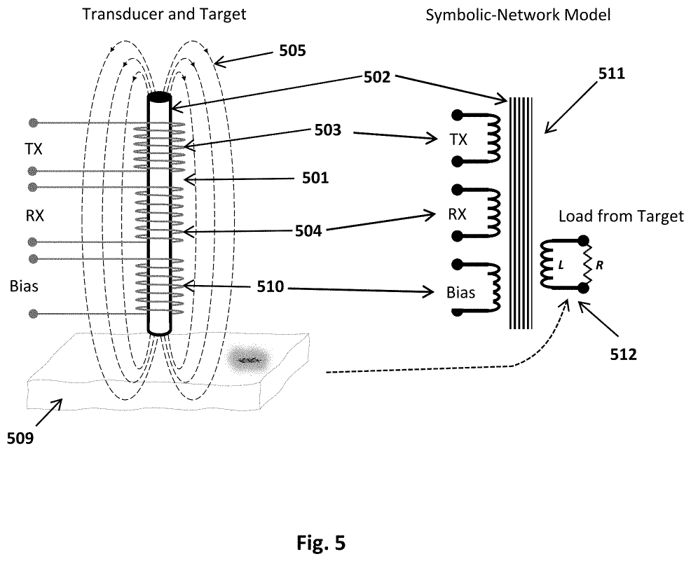

FIG. 5 illustrates the conversion of the physical transducer-target measurement system into a transformer-based symbolic-network model diagram for ease of description and understanding of the invention in the following figures. FIG. 5 shows a transducer 501, the core 502, the transmitter coil 503, and the receiver coil 504 are converted directly into symbols. A bias coil 510 is added as the preferred embodiment of the invention that presents a solution to the challenges described above. The metallic object 509 is represented as a L-R load loop 512 (network) coupled through the core 502. Within the L-R load loop 512, the inductance L is related to the loop path of circular EC 108 decaying over the permeability μₘ of the metal material, and R is related to the resistivity ρₘ of the loop path of the circular EC 108 decaying. When defects are present, the loop resistivity would change, and response would change as well. The transformer-based symbolic-network model 511 is also shown.

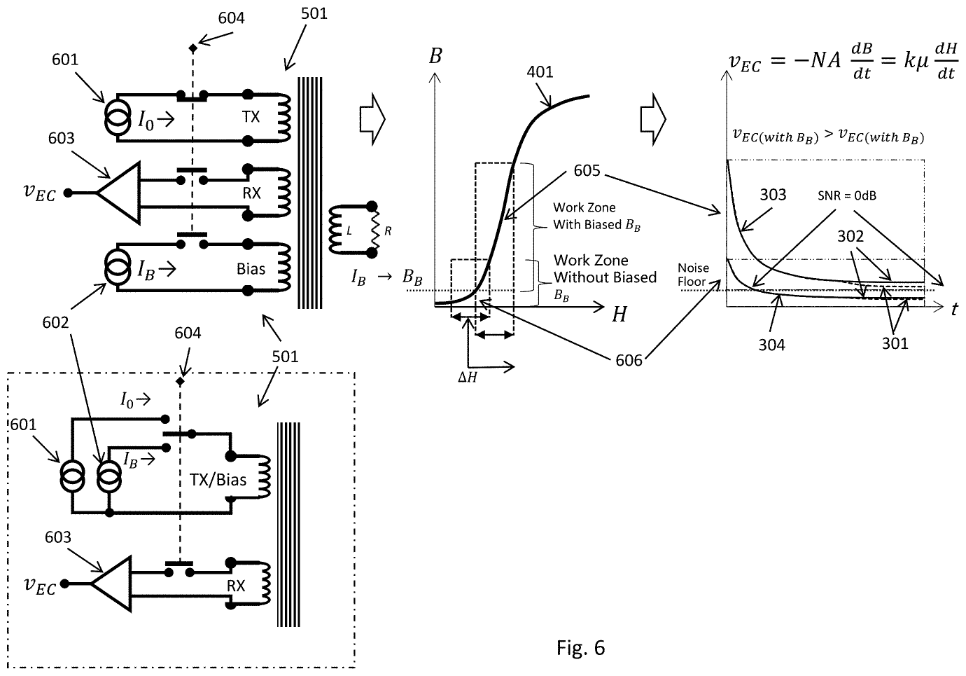

FIG. 6 illustrates the principle of transformer-based symbolic-network model 511 and the resultant effect of using such a bias coil embodiment 510 in PEC measurements. To operate the PEC measurement sequence as illustrated in FIG. 2, the transmitter coil 503 may be connected to an excitation current source 601 through the switch 604 for I₀ charging for the TX duration 201 to provide the initial magnetic field B₀ 505 in the metallic object 509 under inspection. The receiver coil 504 senses the received voltage ν_{EC} 207 that is developed during the acquisition period in response to the EC 108 decaying. The buffer stage 603 provides impedance isolation for the receiver coil 504 from the receiver voltage measurement system. It can also provide a linear gain if needed to map the signal dynamic range to match the dynamic range of the signal channel for measurement systems. The switch 604 is turned off after the TX duration to remove B₀ 505 and the current source 602 is connected to provide current I_{B} to the bias coil to generate the biased magnetic field B_{B} inside the core 502. As mentioned, the bias current I₈ is meant to establish the magnetic bias field B_{B} inside the transducer core 502 in order to shift its permeability to provide higher sensitivity of the receiver coil 504 during the acquisition duration 202, as opposed to the high-level initial charging current I₀ applied to the transmitter coil 503 during the charging duration 201 in order to establish high initial magnetic field B₀ to charge the surrounding metallic object 509. After the time gap 208, the buffer stage 603 is connected through 604 for the period of RX duration 202 for the measurement of received voltage signal ν_{EC}. When the EC 108 generates B_{EC} and the decaying EC 108 produces the magnetic strength range as ΔH, the corresponding magnetic field regions and the magnetic permeability inside the core 502 are different from the work zone 606 without the biased magnetic field B_{B} to the work zone 605 with the biased magnetic field B_{B}. According to Equation (3), the received voltage signal ν_{EC} in the work zone 605 with high permeability is much higher than the voltage signal in the work zone 606 with low permeability, resulting in the measurement signal sensitivity increase due to the addition of the biased magnetic field B_{B}. Furthermore, the differences of the signal responses to the region with the defect on the target 109 against the region without defects are depicted in from 301 to 302.

The comparison of the received signal with different measurement sensitivity and dynamic range with and without adding the biased magnetic field B_{B} is shown in 301 in the region with defect 110 embedded in and 302 in the region without any defects, respectively. With the corresponding noise floor, the SNR of the received signal 303 in the work zone 605 is higher than the received signal 304 in the work zone of 606.

Also, illustrated in FIG. 6 is an exemplary embodiment of sharing the bias coil with the transmitter coil, wherein the transmitter coil 503 may deliver both the charging current I₀ for the magnetic field B₀ generation and the biased current I_{B} to provide biased magnetic field B_{B} in the transducer's core 502. Such an arrangement allows a single transmitter coil 503 to generate both fields sequentially by connecting to the charging current source 601 to the transmitter coil 503 during the TX duration 201 and connecting to the bias current source 602 to the transmitter coil 503 during the RX duration 202 by operating an electronically controlled switch 604 in a pre-programmed sequence for each respective cycle.

As illustrated from the graph in FIG. 6, as the EC magnetic field strength reduces and EC penetrate deeper into the surface of the inspection object 509, the permeability value exhibits a non-linear downwards drift. Along time, the permeability value decreases so much that the system sensitivity becomes very weak. As shown in 606, a portion of the signal which corresponds to the zone of material flaw detection at greater depths is well below the noise floor level, which, when combined with low sensitivity in that area, makes the quantitative analysis of the material defects in that region of depth or distance very difficult if not impossible due to dominant noise sources and almost no sensitivity.

In summary, FIG. 6 illustrates that by changing the work zone using the biased magnetic field inside the core, the permeability value increases, resulting in higher measurement signal sensitivity and SNR. Additionally, the measurement signal dynamic range can be changed and/or increased for better signal mapping or less nonlinearity.

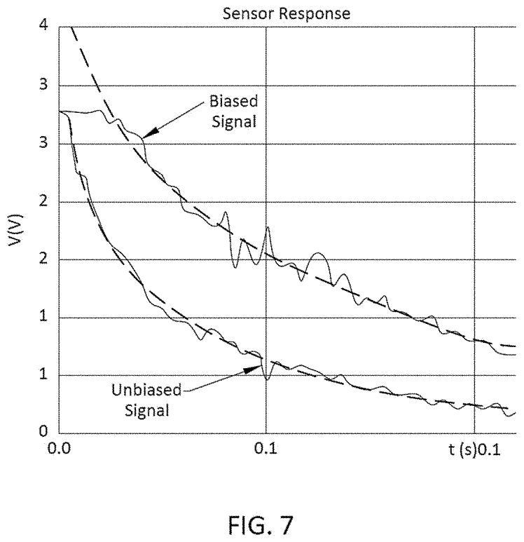

FIG. 7 illustrates the lab experiment results that confirms the differences with or without addition of the biased magnetic field inside the core for the embodiments of the art described above. Both signals show the decaying behavior measuring the same metal target. The “biased signal” with the biased magnetic field in the core is higher than the “unbiased signal” as expected and described in FIG. 6, which proves that the signal sensitivity is higher when the biased magnetic field is added in the core. The noises from the lab environment are shown as the fluctuations around the trend line. The SNR of the biased signal is higher than that of the unbiased signal given the situation of the similar noise conditions for both test cases.

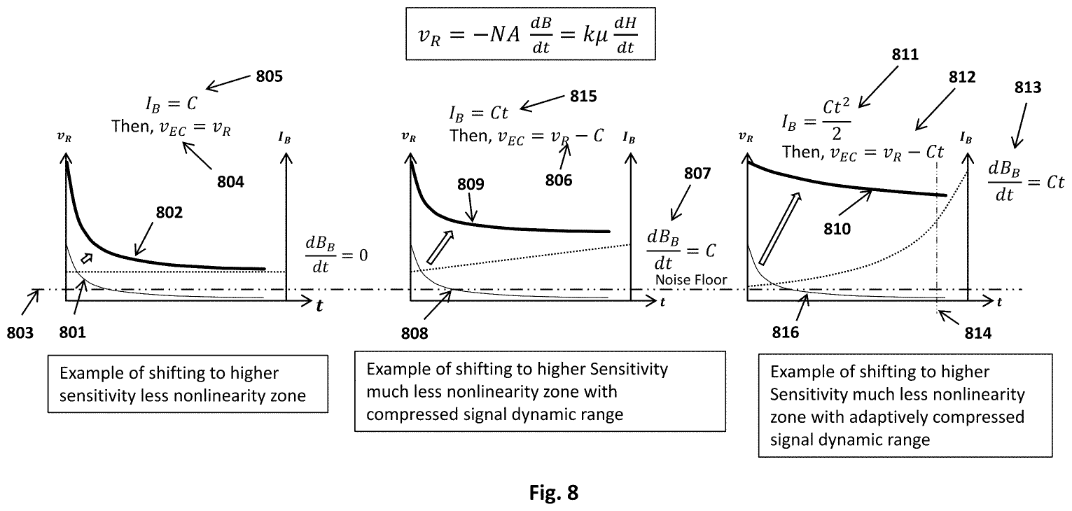

FIG. 8 illustrates that a multiple magnetic field bias control schemes including static, dynamic, and adaptive can be employed. The static method is illustrated in FIG. 6. The biased current I_{B} is a constant I₈=C as in 805, which generates static (DC) biased magnetic field. The received signal ν_{R} is boosted from 801 to 802. As described, the received signal νᵣ from the receiver coil 104 is determined by Equation (3). The static biased magnetic field B_{B} yields

$$\frac{d {B}_{B}}{d t} = 0$$

and the measurement signal ν_{EC} directly related to EC 108 decaying will be ν_{EC}=νᵣ, shown in 804. When the biased magnetic field B_{B} is linearly incremented as shown in 807 which corresponds to the linear current increase I_{B}=Ct along the acquisition time as in 815, the received signal ν_{R} is boosted from 808 to 809, and measurement signal ν_{EC} directly related to the EC 108 decaying will be ν_{EC}=νᵣ−C since

$$\frac{d {B}_{B}}{d t} = C ,$$

shown in 806. A further control function can be chosen to adapt and compress the EC decaying signal dynamic range for the received signal working within a relatively small permeability region to achieve both high sensitivity and high linearity. For example, the biased magnetic field B_{B} may be generated by I_{B} according to a special predefined quadratic function as in 811. The change of B_{B} is known and controlled in 813, where the received signal νᵣ is pushed from 816 to 810, and the measurement signal ν_{EC} directly related to the EC 108 decaying will be ν_{EC}=νᵣ−Ct for

$$\frac{d {B}_{B}}{d t} = C t ,$$

shown in 812. In that case, the received signal ν, has higher voltage level due to the high signal sensitivity, less dynamic range in a better linear permeability region that has further less nonlinearity, and high improvement in SNR. Point 814 serves as an example, when the system noise floor 803 is present compared to the original received signal 816 at the same point of 814. A method for removing the biased field can be employed in the case of linear and functional bias current I_{B} applications so as to remove the artifacts of the changing biased magnetic field from the output signal 207. As the function of the biased magnetic field B_{B} can be mapped in a controlled environment, the artifacts of this field appearing on the output signal can be cancelled out in the signal post-processing domain if needed. The constant bias current case where I_{B}=C and

$$\frac{d {B}_{B}}{d t} = 0$$

does not require this step as the receiver coil 104 is only sensitive to a changing magnetic field where

$$\frac{d {B}_{B}}{d t} \neq 0.$$

In one exemplary embodiment, I_{B} and I₀ are different, I₀ is the charging current to build up the initial magnetic field B₀ in the target, working in the TX duration. Once the charging current I_{B} is switched off, dB₀/dt generates the high Eddy Current I_{EC,0} in the target. Then the EC decays due to the diffusion and damping processes inside the target. Normally, the higher the I₀, the higher the I_{ECO}, the higher the measurement signal ν_{EC}, the higher the SNR for measurement signal. As a result, I₀ can be high in the level of amperes to several hundreds of amperes. I_{B} is the bias current, working in the RX duration when transducer measures

$${v}_{E C} = μ N A \frac{d {H}_{E C}}{d t} .$$

According to ferromagnetic core B-H curve shown in FIG. 4, the permeability μ decreases along the H_{EC} which is corresponding to the EC decaying inside the target. However, adding the bias current I_{B} to the bias coil to generate the bias B field inside the core can push the working point of permeability μ toward the higher region along the B-H curve during RX acquisition time window to increase the measurement signal

$${v}_{E C} = μ N A \frac{d B}{d H}$$

in order to boost SNR. It can also be referred to as boosting the sensitivity of the inductive transducer to make the outside signal much higher given the same EC decaying

$$\frac{d {H}_{E C}}{d t}$$

input corresponding to the same level of EC decaying inside the target. The bias current I_{B} may not be high in value that can charge the target but the bias current I_{B} can be much smaller in the range of small fraction of ampere.

In one exemplary embodiment, the transmitter coil also acts as the magnetic bias coil, wherein the inductive sensor apparatus further includes a switching mechanism configured to alternately connect the transmitter coil to the first current source and the second current source. FIG. 6 shows an exemplary embodiment of the switching mechanism as the switch 604. A circuit network can control the operation of different components and includes the switching mechanism to connect and disconnect different components including the transmitter coil, the receiver coil, and the magnetic bias coils based on a predefined set of rules. The circuit network operates the transmitter coil, by actuating the switching mechanism to connect the transmitter coil to the first current source, for a predetermined charging duration (TX duration), to generate the magnetic field B₀. The circuit network disconnects the transmitter coil, by actuating the switching mechanism to disconnect the transmitter coil from the first current source, after the predetermined charging duration. The circuit network operates the receiver coil for a predetermined acquisition duration to detect the magnetic field generated by induced eddy currents to generate an eddy current voltage signal. The circuit network operates the magnetic bias coil, by actuating the switching mechanism to connect the magnetic bias coil to the second current source, during the predetermined acquisition duration to manipulate the permeability of the ferromagnetic core.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. An inductive sensor apparatus for pulsed eddy current based nondestructive testing of metallic objects, the inductive sensor apparatus comprising:
an inductive coil transducer, wherein the inductive coil transducer comprises:
a ferromagnetic core,
a transmitter coil wound on the ferromagnetic core,
a receiver coil, wound on the ferromagnetic core, wherein the receiver coil is separate from the transmitter coil, and
a magnetic bias coil wound on the ferromagnetic core, wherein the magnetic bias coil is separate from the receiver coil;
a first current source operably coupled to the transmitter coil and configured to apply a charging current I₀ to operate the transmitter coil to generate a magnetic field; and
a second current source operably coupled to the magnetic bias coil and configured to apply a bias current I_{B} to operate the magnetic bias coil to generate a biased magnetic field in the ferromagnetic core, wherein the charging current I₀ and the bias current I_{B} are different.

2. The inductive sensor apparatus of claim 1, wherein the transmitter coil also acts as the magnetic bias coil, wherein the inductive sensor apparatus further comprises a switching mechanism configured to alternately connect the transmitter coil to the first current source and the second current source.

3. The inductive sensor apparatus of claim 1, wherein the bias current I_{B} is less than the charging current I₀.

4. The inductive sensor apparatus of claim 1, wherein the inductive sensor apparatus further comprises a circuit network, the circuit network comprises a switching mechanism, the circuit network configured to:
operate the transmitter coil, by actuating the switching mechanism to connect the transmitter coil to the first current source, for a predetermined charging duration,
disconnect the transmitter coil, by actuating the switching mechanism to disconnect the transmitter coil from the first current source, after the predetermined charging duration,
operate the receiver coil for a predetermined acquisition duration, and
operate the magnetic bias coil, by actuating the switching mechanism to connect the magnetic bias coil to the second current source, during the predetermined acquisition duration.

5. The inductive sensor apparatus of claim 4, wherein the magnetic bias coil is configured to generate the biased magnetic field upon being operated by the circuit network, wherein the biased magnetic field manipulates permeability of the ferromagnetic core.

6. The inductive sensor apparatus of claim 5, wherein the receiver coil is configured to generate an eddy current voltage signal, wherein the circuit network is configured to operate the magnetic bias coil and the receiver coil simultaneously to manipulate the eddy current voltage signal for a higher signal to noise ratio.

7. The inductive sensor apparatus of claim 4, wherein the magnetic bias coil and the second current source are configured to generate the biased magnetic field in the ferromagnetic core that shifts a signal sensing measurement zone to different permeability region(s) on a B-H curve of the ferromagnetic core to obtain one of or a combination of sensing functional performances for received signals with high sensibility, controllable dynamic range, high signal to noise ratio, and improved linearity.

8. A method for pulsed eddy current based nondestructive testing of metallic objects, the method comprising the steps of:
providing an inductive sensor apparatus comprising:
an inductive coil transducer, wherein the inductive coil transducer comprises:
a ferromagnetic core,
a transmitter coil wound on the ferromagnetic core,
a receiver coil, wound on the ferromagnetic core, wherein the receiver coil is separate from the transmitter coil, and
a magnetic bias coil wound on the ferromagnetic core, wherein the magnetic bias coil is separate from the receiver coil,
a first current source operably coupled to the transmitter coil and configured to apply a charging current I₀ to operate the transmitter coil to generate a magnetic field, and
a second current source operably coupled to the magnetic bias coil and configured to apply a bias current I_{B} to operate the magnetic bias coil to generate a biased magnetic field in the ferromagnetic core, wherein the charging current I₀ and the bias current I_{B} are different;
activating the first current source for a predetermined charging duration;
deactivating the first current source after the predetermined charging duration; and
upon deactivating the first current source, activating the second current source during a predetermined acquisition duration.

9. The method according to claim 8, wherein the method further comprises the steps of:
applying the biased magnetic field to the ferromagnetic core, wherein the bias current is a constant current, a linear current, or a functional current with a known first derivative of the function.

10. The method according to claim 8, wherein the method further comprises the steps of:
processing a measured signal to remove effect of the biased magnetic field.

11. The method according to claim 8, wherein the transmitter coil also acts as the magnetic bias coil, wherein the inductive sensor apparatus further comprises a switching mechanism configured to alternately connect the transmitter coil to the first current source and the second current source.

12. The method according to claim 8, wherein the bias current I_{B} is less than the charging current I₀.
